(19) United States
(12) Patent Application Publication
(10) Pub. No.: US 2010/0292867 A1
(43) Pub. Date: Nov. 18, 2010

(54) Motor Vehicle Control Device

(75) Inventors: Frank-Peter Böhm, Berlin (DE); André Hergenhan, Berlin (DE); Stefaan Sonck Thiebaut, Berlin (DE); Robert Mitschke, Berlin (DE); Rolf Morich, Berlin (DE)

Correspondence Address: BEEM PATENT LAW FIRM, 53 W. JACKSON BLVD., SUITE 1352, CHICAGO, IL, 60604-3787, US

(73) Assignee: OPENSYNERGY GMBH, Berlin (DE)

(21) Appl. No.: 12/809,511

(22) PCT Filed: Dec. 19, 2008
(86) PCT No.: PCT/DE2008/002137

§ 371 Date: Jul. 23, 2010

(30) Foreign Application Priority Data
Dec. 21, 2007 (DE) 10 2007 062 114.2

(51) Int. Cl. G06F 19/00; G06F 9/455; G06F 9/46

(52) U.S. Cl. 701/1; 718/1

(57) ABSTRACT

According to the invention, a motor vehicle control device is provided, comprising: a microkernel; several entities; and a software bus, via which the entities can communicate with each other and with the kernel, wherein one or more of the entities represent respectively one or more modules of the AUTOSAR base software. The present invention is based inter alia on the idea of representing the AUTOSAR architecture on a microkernel-based architecture. Thereby, the motor vehicle control device according to the invention makes it possible for example to link infotainment applications with AUTOSAR-based applications.

### CROSS-REFERENCE TO RELATED APPLICATIONS

This application is a U.S. national stage application of PCT application PCT/DE2008/002137, filed Dec. 19, 2008, and claims the benefit of priority from German patent application 10 2007 062 114.2, filed Dec. 21, 2007.

### BACKGROUND OF THE INVENTION

AUTOSAR

AUTomotive Open System Architecture (AUTOSAR) is an international association with the aim of establishing an open standard for electric/electronics architectures in motor vehicles. The members are various automobile manufacturers and suppliers of electronics components.

The following problems are addressed inter alia by AUTOSAR: standardization of important system functions; scalability; relocatability of functions in the vehicle network; integration and exchangeability of software of different manufacturers; support of so-called COTS software.

The specification V2.0.1 has been in existence since the middle of 2006 and can be seen and downloaded from www.autosar.org.

AUTOSAR comprises, inter alia, the following technical features:

AUTOSAR standardizes methods, tools, architectures and functional modules for software development in the automobile industry.

AUTOSAR specifies a component-based approach. Applications are encapsulated in components. Components are basically separated by defined (communication) mechanisms from the underlying infrastructure (hardware and close-to-hardware software).

The model of a system architecture defined in AUTOSAR, designated Virtual Functional Bus—VFB, enables the representation of the components necessary for an automotive overall system and the communication structure thereof independently of their integration site (control unit).

The software architecture defined in AUTOSAR for control units is characterized by three main layers, building on each other. The lowest main layer is called AUTOSAR base software and abstracts from the underlying hardware. The uppermost main layer contains the actual application components. The central main layer, Run Time Environment—RTE, communicates between the application layer and base software.

The AUTOSAR base software consists of a plurality of modules, which in turn belong to different sublayers (layers) and stacks.

The three-layered AUTOSAR system architecture is able to be configured to a high grade: (a) The components of the VFB view can be assigned to various concrete integration platforms (control units). The exchanged signals of the VFB view can be assigned to concrete instances of bus systems as a function of the assigning of the components to control units. (b) As a function of the type and number of the integrated applications, base software and RTE are also configured and integrated. This means that not all models or respectively not all specified module features have to be integrated in a concrete implementation.

The AUTOSAR base software contains modules: for communication via dedicated automotive bus systems, such as CAN-, FlexRay- and LIN-bus, for persistent storage of application and system parameters, for communication with sensors and actuators for interaction with the environment, for error management in automotive systems, and for the management of the system.

A special module of the base software is the operating system AUTOSAR OS. It is an expansion of OSEK OS, which through its mechanisms enables the designing of time-controlled systems, the partitioning of software and the monitoring of temporal characteristics of the software.

The architecture of the AUTOSAR base software and the operating system AUTOSAR OS in fact provide for a modular, but finally nevertheless monolithic implementation.

With the specified modules of the base software, it is possible to create software systems for dedicated automotive functions, also with real time requirements. Applications which can be created therewith are located in the areas of drive, comfort or driver assistance.

### SUMMARY OF THE INVENTION

AUTOSAR is, however, attended by the following disadvantages: AUTOSAR does not specify any dedicated methods, mechanisms and modules for applications from the areas of multimedia, infotainment and the integration of mobile equipment into the car. Due to the architecture of the AUTOSAR base software, it is difficult to insert additional automotive and non-automotive communication channels, such as for example MOST, Ethernet, Bluetooth or USB, which are necessary for the area of multimedia/infotainment. It is not possible to insert transport protocols which can not be used in real time, such as for example TCP/IP) into the AUTOSAR base software. AUTOSAR does not support the use of guest operating systems.

The object of the present invention is to provide a motor vehicle control device which is based on the AUTOSAR standard and nevertheless eliminates or reduces the disadvantages described above.

The present invention is indicated in the independent claims. Advantageous embodiments of the invention are indicated in the sub-claims.

According to the invention, a motor vehicle control device is provided, comprising: a microkernel, several entities; and a software bus, via which the entities can communicate with each other and with the kernel, wherein one or more of the entities respectively represent one or more modules of the AUTOSAR base software.

According to the invention in addition a motor vehicle control device is provided, comprising software for controlling a plurality of applications, wherein the software has the following layers: an application layer with a plurality of applications; a base software layer with a first plurality of AUTOSAR-based base services and a second plurality of AUTOSAR-independent base services, to carry out the applications; an adaption layer with at least a first run time environment, which is assigned to the first plurality of base services, and a second run time environment, which is assigned to the second plurality of base services, wherein the adaption layer connects the application layer with the base software layer; and an operating system layer with a microkernel.

The present invention is based inter alia on the idea of representing the AUTOSAR architecture on a microkernel-based architecture.

A microkernel is a minimal operating system construct, which makes mechanisms available in order to implement operating system services. This comprises substantially: the management of the address space, the provision and management of mechanisms for separating program sections and their thread management, and mechanisms for communication between program sections (Inter-Process-Communication—IPC).

A microkernel comprises inter alia the following technical features: (a) Only the microkernel runs in the privileged “kernel” mode, which can use and utilize all commands and possibilities of a processor. All other program sections run in the “user” mode, to which only limited access rights to the resources of the processor are allocated. This concept is per se highly security-oriented, because all rights are only allocated to the confidential kernel, and the latter monitors all other entities of the system. (b) The components of the operating system which are necessary in addition to the microkernel, such as for instance drivers, protocols, services for applications, are stored as servers in separate entities. These entities are designated below as “building blocks”, see FIG. 2. (c) Applications are also represented as building blocks. (d) The communication between the building blocks takes place via IPC mechanisms. Often, this IPC mechanism is also designated as a software bus, because the connected building blocks communicate with each other via a bus system.

Typical representatives of microkernel operating systems are QNX or L4 implementations.

The invention thus makes it possible to make available an expandable architecture, without in so doing having to depart from the AUTOSAR standard.

Furthermore, it enables a microkernel-based architecture to be able to operate one or more guest operating systems by means of virtualization in addition to the AUTOSAR-OS.

Virtualization is understood to mean a whole variety of concepts in software technology, whose common factor is abstracting from various physical resources. A specific type of this abstracting is named hypervisor or Virtual Machine Monitor (VMM) and makes it possible to run several instances of one or different operating systems on one processor. These instances are designated guest operating systems.

Microkernel-based operating systems are per se good integration platforms for virtualized guest operating systems, because a separation already takes place via the concept of the building blocks. The hypervisor, implemented as server in a building block, does not influence the remainder of the software environment.

Virtualized guest operating systems are known in the context of embedded systems from the fields of industrial automation and mobiles (cell phones). This technology is used there in order to separate software sections which are subject to hard real time requirements from those which have only soft or no real time requirements.

In addition, the motor vehicle control device according to the invention makes it possible to combine time-controlled and event-controlled systems.

Automotive software systems are often time-controlled. This means that the functions of the software system are carried out at particular preset times. In contrast to this, the functions in event-controlled systems are carried out on the occurrence of particular preset events.

The advantage of time-controlled software systems compared with event-controlled systems consists in determinism. The system can be designed so that at every moment it is clear which function (alone) is processed. The system load can therefore be set so that it is balanced at every moment. This is not possible in purely event-controlled conventional systems, because the moment of occurrence of the events is generally unknown. This can lead at particular moments to load peaks, for which the overall system must be designed.

Furthermore, the software application development in automotive engineering frequently takes place today in a model-based manner, by means of tools such as Matlab/Simulink. These tools support the modelling of systems with chronological synchronism, which can be implemented as time-controlled software systems.

The present invention makes it possible to make use of these advantages of time-controlled systems, without at the same time having to dispense with the implementation of event-controlled systems.

For example, the CAN bus system is basically event-controlled. This means that there will be an isolation of the event-controlled bus and of the time-controlled software in the software. Fully time-controlled systems over control unit limits are not possible with this bus system alone. However, the present invention makes it possible to combine the CAN bus system within an automotive control device with time-controlled systems.

For example, the CAN bus system can thereby be combined with a FlexRay bus system. The FlexRay bus system has a synchronous channel and offers its connected nodes (control units) a global time to which they can synchronize themselves. This means that systems which are fully chronologically synchronous/time-controlled are possible. All connected control units or their software have the same time, which serves as the basis for the time-controlled activation of the functionality.

As a whole, the motor vehicle control device according to the invention makes it possible for example to link infotainment applications with AUTOSAR-based applications. Furthermore, the motor vehicle control device according to the invention makes it possible to use virtualized guest operating systems for the separation of software sections with different functional and non-functional characteristics. In addition, it is possible to couple AUTOSAR and virtualized guest operating systems on a single software platform. Furthermore, it is possible to integrate partial systems with different structures, and functional and non-functional requirements on the same, processor-based hardware.

These and other features are explained in more detail below with the aid of example embodiments of the invention.

### BRIEF DESCRIPTION OF THE DRAWINGS

FIG. 1 shows the basic architecture according to an embodiment of the invention.

FIG. 2 shows generally the software bus, kernel and building blocks in a microkernel-based architecture.

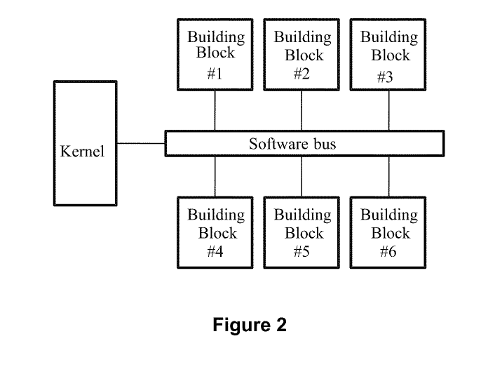

FIG. 3 shows the assignment of modules of an AUTOSAR base software (left-hand side) to building blocks (right-hand side).

FIG. 4 shows the configuration and generation for representing an AUTOSAR base software on a microkernel system and coupling of the tools with the tool chain of AUTOSAR.

FIG. 5 shows a typical scenario of a communication between components of various applications, which are located on different control units.

FIG. 6 shows a possible partitioning of AUTOSAR modules of a communication stack (COM stack) and communication relationships (dashed lines).

FIG. 7 shows a division of the communication stack (Com stack) into two partitions, completely separated from each other, with representation of communication relationships (dashed lines).

FIG. 8 shows diagrammatically the integration of an AUTOSAR-based control with an AUTOSAR-independent infotainment system on a microkernel-based architecture.

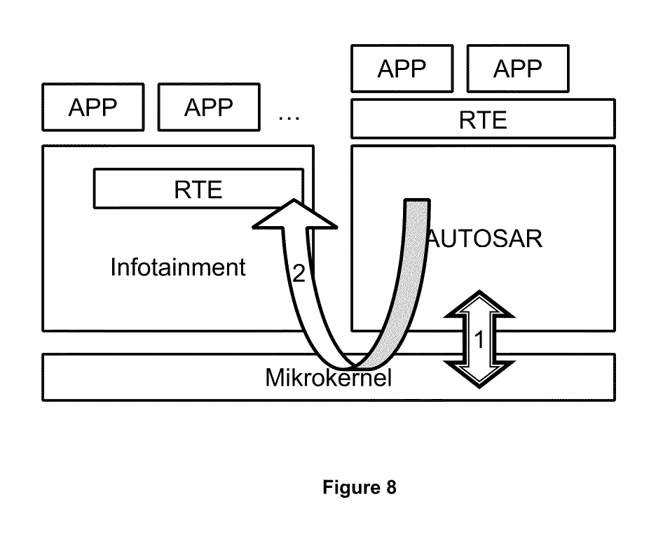

FIGS. 9a (abstract) and 9b (concrete) show the communication relationships between AUTOSAR-based modules (AR1-AR3) and AUTOSAR-independent modules (Inf1-Inf3) in a microkernel-based architecture.

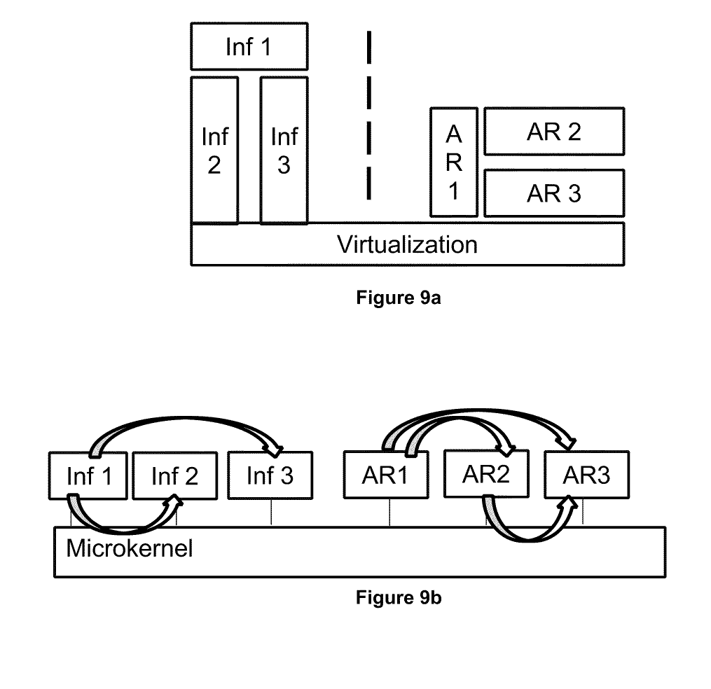

### DETAILED DESCRIPTION

### Embodiments of the Invention

Basic Principle

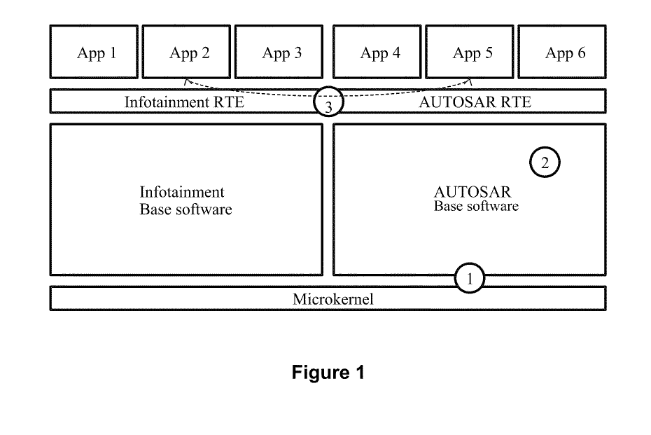

FIG. 1 shows a software architecture of control units in vehicles according to an embodiment of the invention. This architecture differentiates basically between four layers: an application layer; a base software layer, which abstracts form the hardware and offers basic services; a configurable adaption layer—Run Time Environment, RTE, which connects applications and base software; and a basic operating system layer, which is given through a microkernel.

FIG. 1 further shows a vertical division: the right-hand side comprises automotive applications that can be used in real time, and base software components which are covered by AUTOSAR modules; and the left-hand side comprises applications and base software components which are used in automotive multimedia or infotainment applications.

The architecture illustrated in FIG. 1 is able to integrate partial systems with different structures, and functional and non-functional requirements on the same, processor-based hardware.

According to an embodiment of the invention, the monolithic architecture of the AUTOSAR base software is represented on a microkernel-based architecture and this is used for implementations of the AUTOSAR base software (see FIG. 1, reference 1).

This procedure has several advantages: It supports the modularization of the software. It supports the component-based design of software systems specified by AUTOSAR. It supports the minimizing of the effects of faulty software and side effects. It opens up the possibility of integrating additional modules of the base software, currently not taken into consideration by the AUTOSAR architecture, in a simple and well-defined manner. It opens up the possibility of integrating AUTOSAR and virtualized guest operating systems on a hardware platform and thus making use of the advantages from several run time environments for an overall system. It makes it possible to control accesses to resources via dedicated policies.

This process of representation and implementation can be automated.

In the representation and implementation, inter alia the following criteria are taken into consideration and features realized: Criteria for the representation of the AUTOSAR modules on building blocks. Definition of a process for tool-supported representation. Static configuration of system, building blocks and module instances within the building blocks. Dynamic configuration and updates of system, building blocks and module instances in the different run time systems of the architecture of FIG. 1. Criteria for policies for building blocks. Synchronization of building blocks or respectively threads in microkernel-based architectures in time-controlled systems. Synchronization of the microkernel-based architecture to external clocks, for example in FlexRay systems.

According to an embodiment of the invention, the configurable adaption layer RTE of AUTOSAR is also applied to other run time environments (see FIG. 1, reference 3). In the concrete case of the architecture of FIG. 1, this means: Introduction of a RTE for the infotainment environment, which separates the infotainment applications from the infotainment base software (left-hand side in the architecture); the RTE follows the same requirements and specifications as the AUTOSAR RTE; the two RTEs of the right- and left-hand side of the architecture can basically communicate with each other via IPC mechanisms of the microkernel; applications of the right- and left-hand side of the architecture can therefore communicate with each other via standardized mechanisms of the RTE; applications of the right- and left-hand side of the architecture are relocatable in certain limits, i.e. applications of the right-hand side can basically be integrated on the left-hand side, owing to their mechanisms, and vice versa; and superordinate functionalities can be composed from software elements of both sides respectively and thus make use of the special characteristics of both sides.

In FIG. 1, two run time environments are illustrated. However, further run time environments can also be provided. All run time environments can be embodied for communication with each other via IPC mechanisms of the microkernel.

Modularization of the Software

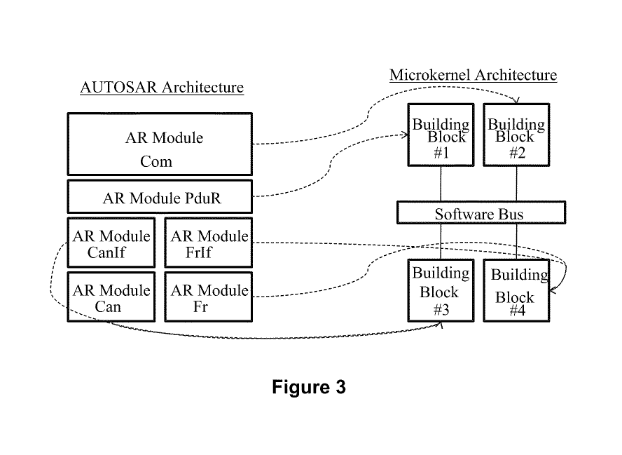

According to an embodiment of the invention, the individual modules of the monolithic architecture of the AUTOSAR base software are represented on the building blocks of the microkernel-based architecture (see FIG. 3). Each building block functions as a server, i.e. each building block offers services for all the others. The APIs of the module specifications, which are exported to the “exterior” as services, are transformed for this to corresponding IPC mechanisms. As the mechanisms which are involved are well defined, this adaption can take place in an automated manner.

In the process of assignment, basically a decision must be made as to which modules are represented on a common building block. Basically, there are the following variants: (a) Each module of the AUTOSAR base software is implemented in a building block. In this case, any communication between the modules takes place via IPC mechanisms. This variant is not preferred, because it is relatively “costly”; each AUTOSAR module must be designed as a server, each communication takes place via additional indirections. (b) The entirety of the AUTOSAR base software is represented in a building block. The communication within the base software takes place via the mechanisms described in AUTOSAR. The communication with other building blocks, for example those which encapsulate AUTOSAR components, takes place via IPC mechanisms. This variant therefore constitutes a virtualized AUTOSAR system. However, the advantages of modular microkernel-based architectures are for the most part lost here. (c) A preferred variant is shown in FIG. 3 and is a compromise of the preceding extremes. It is possible to represent both several modules jointly and also only individual modules of the AUTOSAR base software on building blocks. This variant is preferred, because it both emphasizes the modularization and also takes into consideration the additional costs through the representation on the microkernel architecture.

According to the invention, no generally accepted representation rules, presentable in closed form, are provided for the representation of modules on building blocks. However, criteria according to preferred embodiments of the invention can be: (a) Minimizing of the number of building blocks: This has its correspondence in the AUTOSAR conformance classes ICC1, ICC2 or respectively ICC3. (b) Clusters, which belong together logically, functionally: The modules of the AUTOSAR memory stack have relative few interactions with other AUTOSAR modules and can therefore be combined to one building block. (c) Clusters which belong together commercially: The module of the I/O hardware abstraction and other I/O-relevant modules are offered commercially by one firm and are therefore also encapsulated in one building block. (d) Clusters which are formed on account of security aspects: e.g. the modules of the CAN communication stack are separated from each other from the modules of the FlexRay communication stack by the representation on different building blocks. (e) Clusters, which are formed on the basis of existing legacy software. (f) Other criteria.

Component-Based Approach

AUTOSAR software components are encapsulated in building blocks. In the representation of the AUTOSAR software components, the same considerations apply as for the representations of modules on building blocks (see above). The mechanisms of the module AUTOSAR RTE are represented on the mechanisms of the software bus and possibly additional functionalities in separate building blocks.

Minimizing of the Effects of Errors and Side Effects

The limits of building blocks can basically also be limits of separated software partitions. Building blocks can have various privileges here. In this case, building blocks can not influence each other reciprocally, the sub-systems in the respective building blocks know nothing of the other respectively. Side effects are not to be expected in the respectively other software partition.

Errors and effects of errors can be encapsulated in the building blocks. Fatal failures in one building block have no effects on another. Therefore, error active chains can be effectively interrupted.

Building blocks can be started again separately after failures. This possibility basically increases the reliability and availability of the system.

Integration of Additional Modules

The concept of the building blocks forms a simple mechanism for integrating additional modules. This additional functionality exists per se independently of the remaining modules of the AUTOSAR base software. These additional modules export services to the exterior via their server interface. It is for the modules of the AUTOSAR base software to make use of these via expansions. An expanded RTE could, for example, make functionality of the MOST communication stack available for AUTOSAR software components.

AUTOSAR and Virtualized Guest Operating Systems

AUTOSAR in a microkernel-based operating system can be coupled with a guest operating system. The overall system makes use here of the advantages of the standardized AUTOSAR architecture and the advantages of the (for example likewise standardized) guest operating system. AUTOSAR is implemented here in the manner described above. The guest operating system is integrated via a hypervisor implemented in a building block.

Drivers that can be used in real time, which go beyond the already existing functionality of the AUTOSAR base software, are implemented in additional building blocks. The functionality can now be accessed via IPC communication. In the case where both the guest operating system and also expanded AUTOSAR modules access simultaneously, additionally implemented policies are required, in order to ensure the temporal behaviour, the security and the integrity of the overall system.

Automation

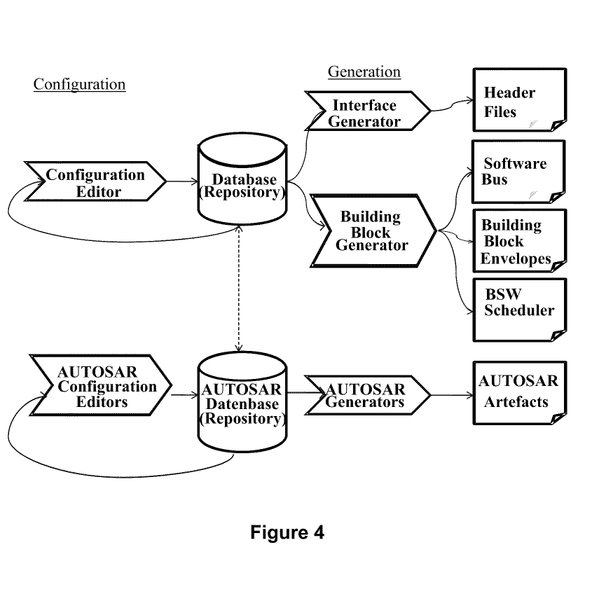

Owing to the challenges and degrees of freedom described in the points above when finding suitable representation provisions, the representation process is embodied so as to be able to be configured. The representation rules are therefore able to be selected per project. A series of downstream configurations of the building blocks and of the modules within the building blocks result from the assignment of AUTOSAR modules to building blocks. The configurable representation process consists of a configuration- and a generation step and is necessarily supported by tools. A minimal set of tools contains a configuration editor, an interface generator and a building block generator. The functions of the AUTOSAR module “BSW Scheduler” are also created by the configuration/generation processes. The tools are integrated into the AUTOSAR tool chain. See FIG. 4.

Configuration Editor

The configuration editor makes possible: the representation of AUTOSAR modules on building blocks; the describing of representation rules (for the automatic and semi-automatic assignment of AUTOSAR modules to building blocks); the representation of APIs of the AUTOSAR modules to exported IPC Interfaces of the associated building blocks; the description (establishing) of behaviour of the exported interfaces; the representation of “schedulable objects” of the AUTOSAR modules on threads of the microkernel system; the allocation of priorities to threads; the establishing of schedules (course sequences of threads); the allocation of the implementation of synchronization mechanisms and atomic accesses to exclusive resources (interrupt locks, semaphores, etc.); and the allocation of particular policies for particular accesses to building blocks.

The actual configuration can take place here basically automatically, semi-automatically or manually.

The configuration editor has access to a database, which: contains links to the AUTOSAR modules which are to be assigned; and links to the APIs, “schedulable objects” and further characteristics which are to be implemented (for example synchronization points, exclusive access to resources).

The configuration results are written into a database.

Interface Generator

The interface generator generates the necessary IPC interfaces per building block in the form of header files. The interface generator has access to the results of the configuration process, but in particular to: the results of the representation of the APIs of the AUTOSAR modules on the exported interfaces per building block; and the behaviour description of the IPC interfaces.

Building Block Generator

The building block generator generates the software bus, the integration envelopes of the building blocks and the functionality of the “BSW scheduler” module. The building block generator has access to the results of the configuration process, in particular, however, to: the results of the representation of AUTOSAR modules to building blocks; the descriptions of structure and behaviour of the IPC interfaces of the building blocks; the information concerning the required threads, their priorities and schedules; the allocations of functionalities to threads; the allocation of particular policies of building blocks; and the implementation instructions for synchronization and for accesses to exclusive resources.

The generated software bus is the entirety of all IPC communications between the building blocks involved. The integration envelopes communicate between the interfaces of the building blocks and the exported APIs of the AUTOSAR module instances in the case where the building blocks contain modules of the base software. In the case where building blocks contain applications, the integration envelopes are the implemented AUTOSAR RTE. The functionality of the BSW scheduler module is generated separately for each AUTOSAR module instance within a building block.

Further Tools

Further tools are conceivable to support the representation heuristics. Analysis tools can for example take into consideration the temporal behaviour in the allocation of AUTOSAR modules to building blocks.

Expansions

AUTOSAR proceeds from a static configuration of the software. This means that the configuration of the software is set at the start of the run time. An expansion of the system presented above to dynamic configurations, i.e. carried out at the run time, is conceivable.

A specific case of application for a dynamic configuration is the actualization of software during the life cycle of a control unit. The inherent modularization of microkernel architectures facilitates the implementation of this case of application.

Operating System AUTOSAR OS

Microkernel-based operating systems are operating systems and therefore offer at least one generally accepted set of basic functions. In this respect, it is basically possible technically to represent the basic functionality of an AUTOSAR OS on a microkernel-based operating system.

The representation of this basic functionality already offers some degrees of freedom in realization. The specification of the AUTOSAR OS offers the possibility of an adaption layer which adapts one system to the other. The philosophy behind this, however, corresponds more to that of a monolithic structure and less to that of a modular microkernel system. This possibility is therefore rejected.

Instead of this, according to an embodiment of the invention provision is made to make use implicitly of the characteristics of a microkernel system, in order to represent the required functionalities of the AUTOSAR OS. For example, the AUTOSAR OS object “task” is represented implicitly by the use of the existing objects “tasks/protection domains” or respectively “threads”.

Furthermore, non-trivial problems exist in the representation of the AUTOSAR OS functionality by means of a microkernel operating system. This includes: the temporal synchronization to external or respectively global times; and the monitoring of predetermined temporal characteristics of threads/tasks and of the general (temporal) course.

The monitoring of the memory areas of particular software partitions, required by the AUTOSAR OS, mostly exists through microkernel systems. Particular memory areas which are monitored by the microkernel are allocated to building blocks.

From the above comments on time-controlled and event-controlled systems, it necessarily follows that the operating systems of the control units linked to the FlexRay bus must offer the possibility of being able to synchronize themselves to the global time. Only in this case are fully synchronous/time-controlled systems over control unit limits possible at all.

In the synchronized state, a control unit 1 is able to deliver in the one particular moment information to a reserved synchronous slot of the bus system (FlexRay), which can then be received by another control unit 2 at the same or another fixed moment and further processed.

The synchronization between global time (in FlexRay given by the bus) and the times of the connected nodes is to take place continuously. Jitter and the divergence of the times are possible through the technical limits of the systems (hardware and software).

AUTOSAR requires from an AUTOSAR operating system the possibility of synchronization to external and global times. The synchronization of the operating systems to a global time is no trivial problem. Generally, adaptations to the scheduler of the operating system are necessary. A “normal” microkernel-based system generally offers no standard mechanisms for this. This means that the scheduling mechanisms of the microkernel-based system are expanded by the possibilities of synchronizing to external or respectively global times. Furthermore, the scheduler is expanded by the possibility of running threads or respectively tasks cyclically or acyclically according to a time scheme (absolutely or relative to particular global times).

Example for the Representation of Modules on Building Blocks of the Microkernel System

Scenario

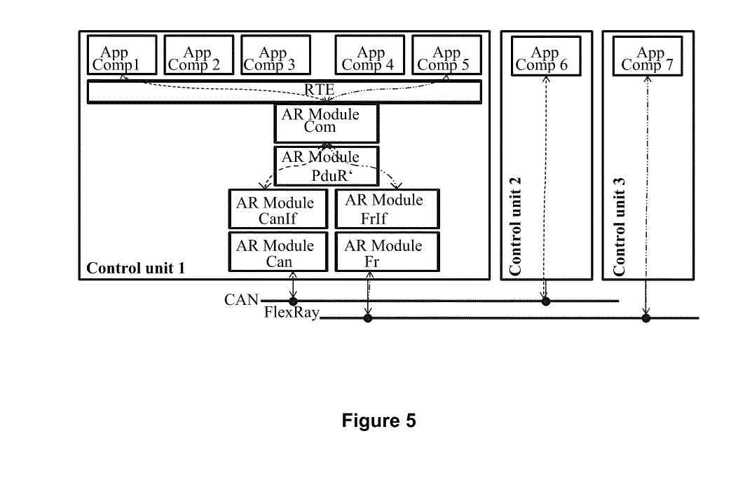

FIG. 5 shows a typical communication scenario in automotive systems. Application components of different control units communicate with each other by exchanging signals via external buses or internally.

The communication stack illustrated in the representation of the control unit 1 corresponds to the AUTOSAR architecture of the base software. The modules are illustrated which are necessary for the communication via the CAN bus or respectively FlexRay bus.

FIG. 5 shows that there are jointly used modules for the communication via the different buses, namely the Com module and the Pdu router module PduR: the application component 1 of the control unit 1 is to be able to communicate via the CAN bus with the application component 6; the application component 5 of the control unit 1 is to be able to communicate via the FlexRay bus with the application component 7; the application components App-Comp 1-3 are to be supplied by one supplier, and the components App-Comp 4 and 5 are to be supplied by a second supplier.

Simple Representation of the Communication Stack

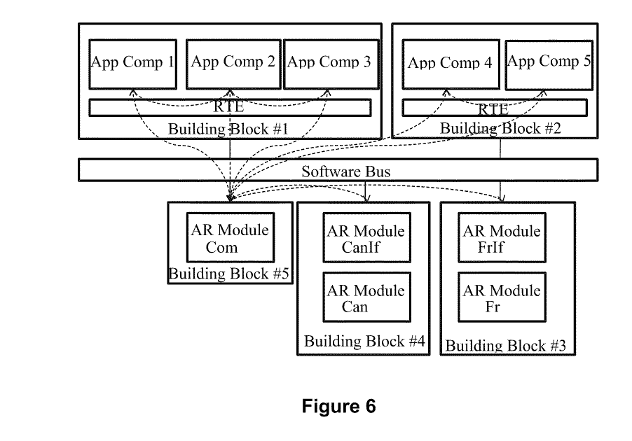

FIG. 6 shows a first possible representation of the scenario illustrated in FIG. 5. The application components App-Comp 1-3 or respectively 4-5 are encapsulated in separate building blocks (building block #1 or respectively #2), as the components come from different suppliers respectively. The “RTEs” for the components App-Comp 1-3 or respectively 4 and 5 ensure the respective coupling to the software bus, corresponding to the necessary interfaces. This applies both for the services or respectively signals which are made available and also for the required services and signals.

The module of the base software Com-module ensures for all buses the conversion of the signals of the application components to messages of the respective bus with corresponding schedules. As it is module used by all bus types and instances, it is implemented in a separate building bock (#5).

For various reasons, the respective bus types (here CAN bus and FlexRay bus) are implemented in separate building blocks: CAN bus and FlexRay bus have very different behaviour characteristics; in addition, Can- or respectively FlexRay modules can potentially come from different suppliers.

The module Pdu router disappears completely in this module representation. The routing characteristics of the module (from the Com module to the module stacks of particular bus systems) can be covered completely by the software bus or respectively the IPC mechanisms of the microkernel.

Instantiated Communication Stack

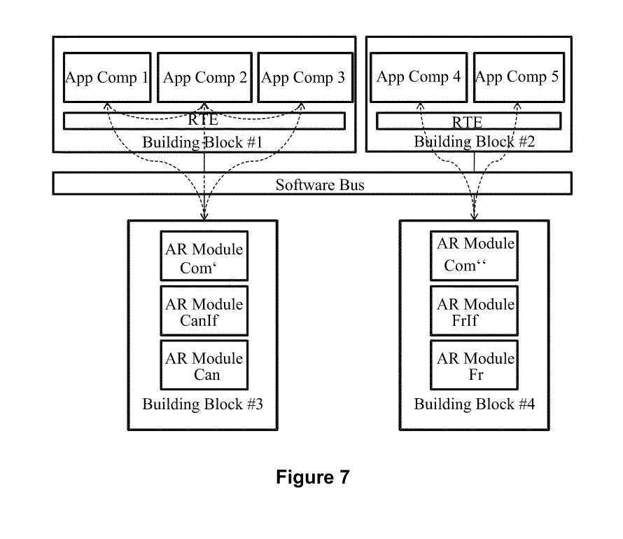

FIG. 7 shows an alternative embodiment of the scenario illustrated in FIG. 5. The application components are represented in the same manner as explained in the preceding section.

The difference to the solution from the preceding section lies in the different representation of the communication stack. In the solution of FIG. 7, there are respectively complete stacks for the different bus systems. In contrast to the preceding solution, there is no longer a divided instance of the AUTOSAR module Com, but rather a special instance of the Com module respectively for the different bus systems. This is possible through the special characteristics of the Com module. The characteristics are namely configurable per message (message or Protocol Data Unit (PDU)). However, different bus systems use different PDUs in each case. This also means, however, that variously configured instances of the Com module can be generated for different bus systems.

This approach can also be applied to various instances of a bus system.

Example for the Implementation of the Infotainment Base Software

The base software for the infotainment system can be implemented for example by an “Embedded Linux” system or Microsoft AUTO system.

1. Motor vehicle control device, comprising:
a microkernel;
several entities; and
a software bus, via which the entities can communicate with each other and with the microkernel,
wherein one or more of the entities respectively represent one or more modules of the AUTOSAR base software.

2. Motor vehicle control device according to claim 1, wherein each entity is embodied as a server, in order to make access possible for the other entities to the services thereof.

3. Motor vehicle control device according to claim 1, wherein the APIs of modules of the AUTOSAR base software are represented by corresponding IPC mechanisms between the entities.

4. Motor vehicle control device according to claim 1, wherein at least one of the entities provides a time-controlled system and at least one other of the entities provides an event-controlled system.

5. Motor vehicle control device according to claim 4, wherein the time-controlled system is formed by a FlexRay bus and the event-controlled system is formed by a CAN bus.

6. Motor vehicle control device according to claim 1, wherein the modules are represented on the entities according to one of the AUTOSAR conformance classes.

7. Motor vehicle control device according to claim 1, wherein the modules of the memory stack of the AUTOSAR base software are represented by one of the entities.

8. Motor vehicle control device according to claim 1, wherein the I/O-relevant modules of the AUTOSAR base software are represented by one of the entities.

9. Motor vehicle control device according to claim 1, comprising at least one guest operating system, which is assigned to one of the entities and is thereby integrated into the motor vehicle control device.

10. Motor vehicle control device according to claim 9, wherein the guest operating system is integrated into the motor vehicle control device as a virtualized guest operating system by means of a hypervisor implemented by one of the entities.

11. Motor vehicle control device according to claim 1, wherein one or more of the entities implement the AUTOSAR operating system.

12. Motor vehicle control device according to claim 1, comprising one or more drivers that can be used in real time, which are implemented jointly or respectively through one of more of the entities.

13. Motor vehicle control device according to claim 1, wherein one or more of the entities implement automotive infotainment services.

14. Motor vehicle control device according to claim 1, wherein one or more of the entities provide a MOST, Ethernet, Bluetooth and/or USB interface.

15. Tool for the representation of modules of the AUTOSAR base software on the entities of a motor vehicle control device according to one of the preceding claims, comprising:
means for determining how the modules of the AUTOSAR base software are to be represented on the entities;
means for the production of IPC interfaces of the entities; and
means for the production of the bus and of a base software scheduler module.

16. Motor vehicle control device, comprising software for controlling a plurality of applications, wherein the software has the following layers:
an application layer with the plurality of applications;
a base software layer with a first plurality of AUTOSAR-based base services and a second plurality of AUTOSAR-independent base services, to carry out the applications;
an adaption layer with at least a first run time environment, which is assigned to the first plurality of base services, and a second run time environment, which is assigned to the second plurality of base services, wherein the adaption layer connects the application layer with the base software layer; and
an operating system layer with a microkernel.

17. Motor vehicle control device according to claim 16, wherein the run time environments for communication with each other are embodied via IPC mechanisms of the microkernel.

18. Motor vehicle control device according to claim 17, wherein a first part of the applications is assigned to the first run time environment, and a second part of the applications is assigned to the second run time environment, and wherein the applications can communicate with each other via the first and second run time environments.

19. Motor vehicle control device according to claim 16, wherein the first plurality of base services is embodied for carrying out control applications which can be used in real time.

20. Motor vehicle control device according to claim 16, wherein the second plurality of base services is embodied for carrying out infotainment applications.
